(19) United States
(12) Patent Application Publication
(10) Pub. No.: US 2006/0089578 A1
(43) Pub. Date: Apr. 27, 2006

(54) Universally rotatable twin-ball massage device

(76) Inventor: Tsang-Hung Hsu, Taoyuan (TW)

Correspondence Address: Tsang-Hung Hsu, P.O. Box 55-846, Taipei, 104, TW

(21) Appl. No.: 10/974,570

(22) Filed: Oct. 26, 2004

(51) Int. Cl. A61H 15/00

(52) U.S. Cl. 601/118; 601/121; 601/125; 601/137

(57) ABSTRACT

A massage device includes: a pair of massage balls juxtapositionally rotatably mounted on a linking shaft, a rotating spacer formed on a middle portion of the shaft and rotatably or universally spaced in between the two balls, and each ball being comprised of a pair of semi-spherical shells which are respectively rotatably engaged with a pair of pivoting shafts, with each pivoting shaft perpendicular to the linking shaft, thereby providing universally rotating balls or shells for a comfortable massage especially within the user's single hand or palm by his or her single hand.

### BACKGROUND OF THE INVENTION

U.S. Pat. No. 4,846,159 disclosed a massage apparatus comprising two balls for various massage manner. However, the balls (3) are enclosed in a case (1) and are not suitable for massage in a user's hand or palm by a single hand. In other words, when the user wants to massage his or her hand or palm, his or her another hand should hold the case (1) to allow the two balls (3) rotatably mounted on the case (1) to massage the palm or fingers of the user's hand, thereby limiting the massage manner or functions.

The present inventor has found the drawbacks of the conventional massage apparatus and invented the present massage device having twin balls universally rotatably held within the user's single hand or palm.

### SUMMARY OF THE INVENTION

The object of the present invention is to provide a massage device including: a pair of massage balls juxtapositionally rotatably mounted on a linking shaft, a rotating spacer formed on a middle portion of the shaft and rotatably or universally spaced in between the two balls, and each ball being comprised of a pair of semi-spherical shells which are respectively rotatably engaged with a pair of pivoting shafts, with each pivoting shaft perpendicular to the linking shaft, thereby providing universally rotating balls or shells for a comfortable massage especially within the user's single hand or palm by his or her single hand.

### BRIEF DESCRIPTION OF THE DRAWINGS

FIG. 1 shows a massage device of the present invention.

FIG. 2 is an exploded view showing the elements of the present invention.

FIG. 3 shows a ball dismantled from the massage device of the present invention.

FIG. 4 is a sectional drawing of the present invention.

FIG. 5 shows a modification of a ball of the present invention.

FIG. 6 shows another preferred rotating spacer of the present invention.

FIG. 7 shows still another preferred rotating spacer of the present invention.

### DETAILED DESCRIPTION

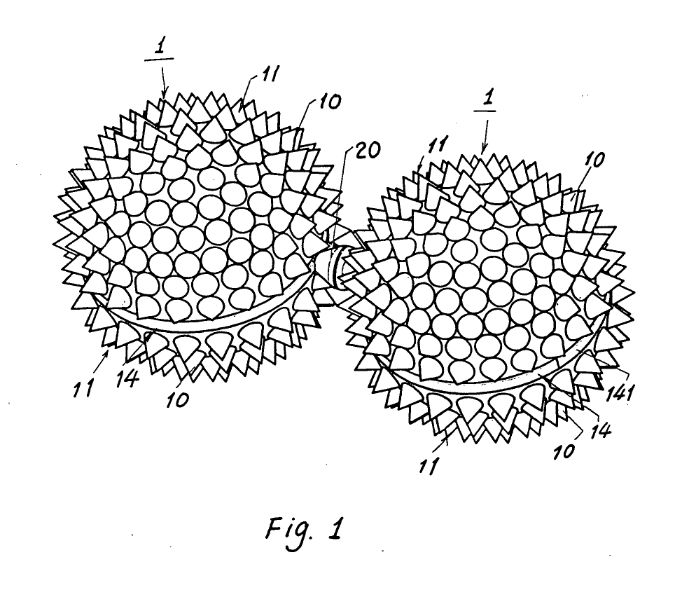

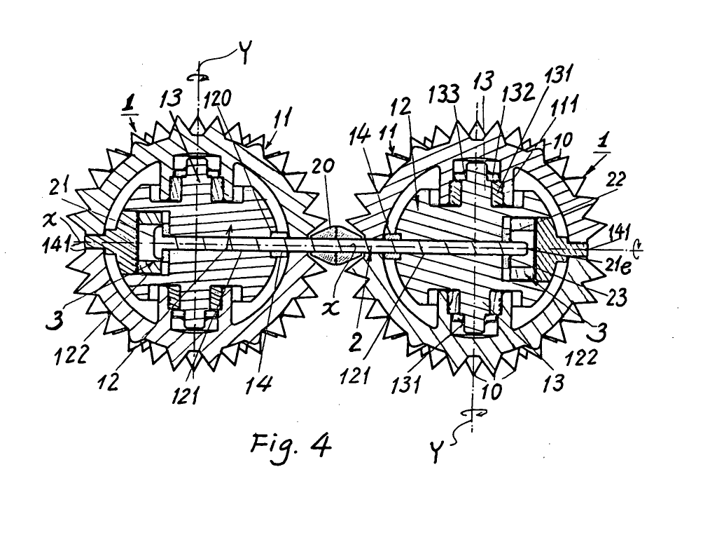

As shown in FIGS. 1˜4, a preferred embodiment of the massage device of the present invention comprises: a pair of massage balls 1 juxtatopositionally rotatably mounted on or disposed about a linking shaft 2 along a latitudinal axis X (FIG. 4) having a rotating spacer 20 formed on a middle portion of the linking shaft 2 for rotatably separating the two massage balls 1.

The linking shaft 2 may be made of flexible materials, durable for bending, twisting or rotation thereof.

Each massage ball 1 includes a pair of semi-spherical shells 11 combinably encasing a weight core 12 therein and respectively rotatably secured on a pair of pivoting shafts 13 diametrically formed on the weight core 12 about a longitudinal axis Y which is defined at a longitudinal center of the pair of pivoting shafts 13 and is perpendicular to the latitudinal axis X of the linking shaft 2, and an equator ring 14 formed in an equator groove 120 equatorially recessed in the weight core 12 for rotatably engaging a circular periphery 112 of each semi-spherical shell 11. Each shell 11 has a plurality of protrusions 10 formed on a spherical surface of the shell 11 for massage purpose.

The core 12 may be made of heavy metals or heavy materials for helping the massage effect on a user's hand.

The weight core 12 and the equator ring 14 secured or formed on the core 12 are diametrically drilled or formed with a shaft hole 121 through the core 12 and the equator ring 14 for rotatably engaging the linking shaft 2 about the latitudinal axis X (FIG. 4).

The semi-spherical shell 11 includes a hub portion 111 formed in a central portion of the shell 11 to be rotatably mounted on the pivoting shaft 13 on the weight core 12.

A bushing 131 is secured in the hub portion 111 of the shell 11 to be rotatably engaged with the pivoting shaft 13, having a washer 132 and a retainer 133 provided on the pivoting shaft 13 to retain the bushing 131 and the shell 11 without being separated from the pivoting shaft 13 of the core 12.

The linking shaft 2 has a first end 21 fastened to a first core 12 by a washer 22 in a first ball 1 (such as the left ball shown in FIG. 4), and having a second end 21e fastened to a second core of a second ball 1 (such as the right ball shown in FIG. 4) by a washer 22 and retainer 23.

The weight core 12 includes an end cavity 122 formed in an outer portion of the core 12 opposite to the rotating spacer 20 and enlarged from a shaft hole 121 formed through the core 12 for storing a magnet 3 in the end cavity 122 for producing magnetic force for magnetically stimulating the user's body for enhancing a better blood circulation of the user in cooperation with the massage effect as effected by the protrusions 10 formed on the spherical ball 1.

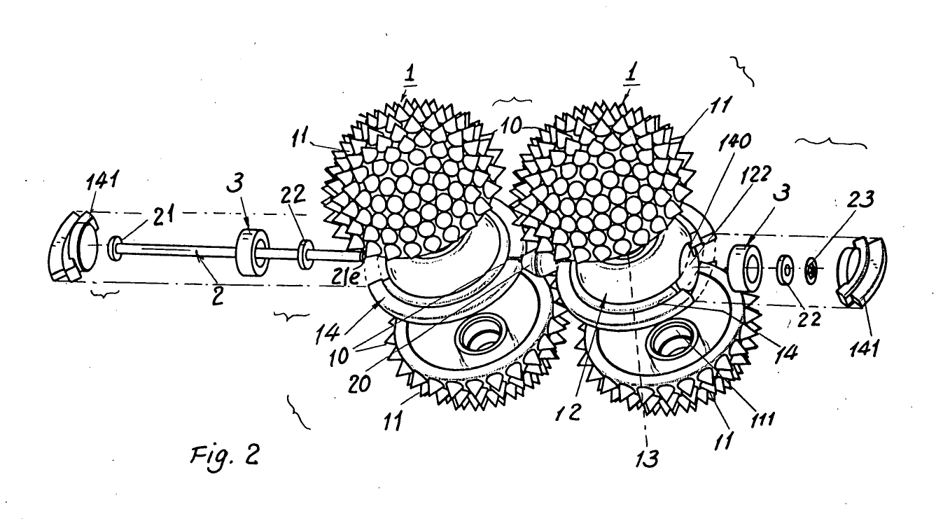

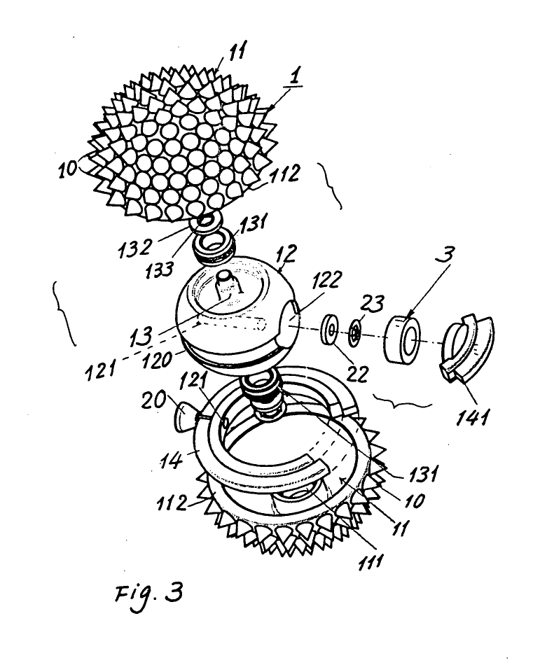

An end plug 141, movably engaged with an arcuate notch 140 as annularly cut out in a perimeter portion of the equator ring 14, and radially corresponding to the end cavity 122, is provided to seal the end cavity 122 in the weight core 12 and to fill the notch 140 as cut out in the equator ring 14 (as shown in dotted line in FIGS. 3, 2), thereby completing an annular equator ring 14 for a smooth rotational engagement of the periphery 112 of the shell 11 on the equator ring 14.

Accordingly, the balls 1 can be rotated about the latitudinal axis X by simultaneously rotating both balls 1, 1 or alternatively rotating either ball 1 about the linking shaft 2 (axis X). Also, each semi-spherical shell 11 of the ball 1 may also be rotated about the pivoting shaft 13 (axis Y) to be perpendicular to the axis X. So, the two balls or either ball may be rotated universally in any orientation or direction within a single hand or palm of the user for comfortably massaging uses.

By eliminating the case (1) of the prior art (U.S. Pat. No. 4,846,159), the balls can be freely smoothly and ergonomically manipulated in a single hand or palm (just by single hand) for a better massaging than the prior art.

The rotating spacer 20 may be formed as a single piece or by combining two half pieces, not limited in this invention. It is preferably made as spherical, elliptical or conical shapes for a smooth rotatable spacing or separation of the two balls 1, also not limited.

The spacer 20 will prevent from tangling or obstruction of the two balls rotatably coupled mutually.

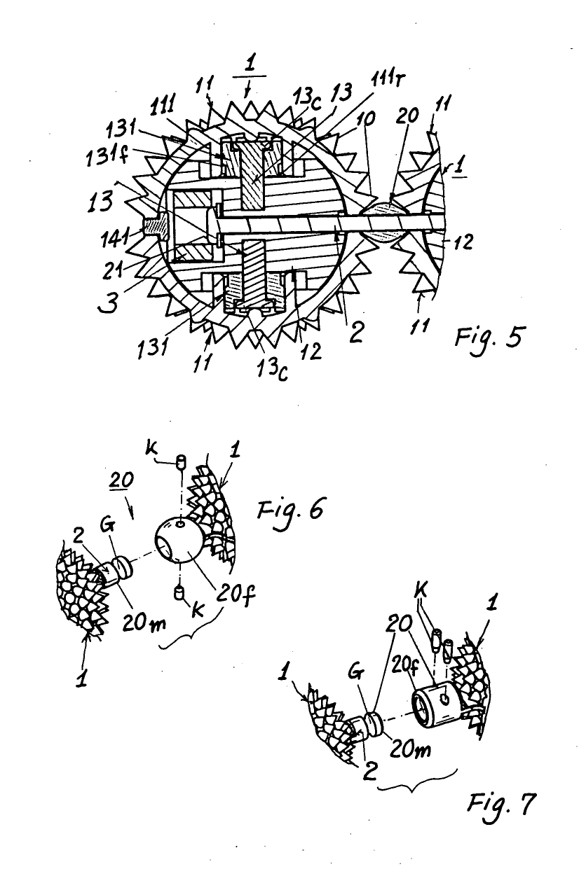

As shown in FIG. 5, the pivoting shaft 13 may be modified to be a pin-like pivoting shaft 13 fixed into the weight core, having an end cap 13c for limiting the bushing 131 secured in the hub portion 111. The hub portion 111 includes ratchet teeth 111r for engaging a flange 131f formed on the bushing 131 for a quick fastening of the bushing 131 in the hub portion 111 of the shell 11.

Other mechanisms for rotatably engaging the shell 11 on the pivoting shaft 13 of the core 12 may be modified, without being limited, in accordance with the present invention.

As shown in FIGS. 6, 7, the rotating spacer 20 is modified to include a male part 20m having a key groove G annularly recessed in the male part 20m, and a female part 20f engaged with the male part 20m by inserting a pair of keys K into the key groove G either radially (FIG. 6) or tangentially (FIG. 7), thereby rotatably coupling the male part 20m with the female part 20f of the rotating spacer 20 for enhancing a free relative rotation between the two balls 1, 1.

The present invention provides a universally rotatable massaging device having twin balls universally or rotatably coupled with each other to be well operated in a user's hand by his or her single hand for enhancing a massage effect.

Naturally, the twin-ball massage device of the present invention may also be used to massage any other body portion, not limited to the user's hand or palm portion.

The shell 11 and its protrusions 10 may be made of plastic, rubber or any other elastomer materials, not limited in this invention.

The present invention may be further modified without departing from the spirit and scope of the present invention.

I claim:

1. A massage device comprising: a pair of massage balls juxtatopositionally rotatably mounted on a linking shaft along a latitudinal axis (X), having a rotating spacer formed on a middle portion of the linking shaft for rotatably spacing the two massage balls.

2. A massage device according to claim 1, wherein said linking shaft is formed as flexible.

3. A massage device according to claim 1, wherein each said massage ball includes a pair of semi-spherical shells combinably encasing a weight core therein and respectively rotatably secured on a pair of pivoting shafts diametrically formed on the weight core about a longitudinal axis (Y) which is defined at a longitudinal center of the pair of pivoting shafts and is perpendicular to the latitudinal axis (X) of the linking shaft, and an equator ring equatorially formed in the weight core for rotatably engaging a circular periphery of each said semi-spherical shell; each said shell having a plurality of protrusions formed on a spherical surface of the shell for massage.

4. A massage device according to claim 3, wherein said equator ring is engaged in an equator groove equatorially recessed in said core.

5. A massage device according to claim 3, wherein said weight core and said equator ring formed on the core are diametrically formed with a shaft hole through the core and the equator ring for rotatably engaging the linking shaft about the latitudinal axis (X).

6. A massage device according to claim 3, wherein said semi-spherical shell includes a hub portion formed in a central portion of the shell to be rotatably mounted on the pivoting shaft on the weight core.

7. A massage device according to claim 6, wherein said shell includes a bushing secured in the hub portion of the shell to be rotatably engaged with the pivoting shaft, having a washer and a retainer provided on the pivoting shaft to limit the bushing and the shell without being separated from the pivoting shaft of the core.

8. A massage device according to claim 3, wherein said weight core includes an end cavity formed in an outer portion of the core corresponding to an outer portion of the equator ring opposite to a rotating spacer between two said balls, and said end cavity enlarged from a shaft hole formed through the core for storing a magnet in the end cavity for producing magnetic force for magnetically stimulating a user's body.

9. A massage device according to claim 8, wherein said weight core includes an end plug, movably engaged with an arcuate notch as annularly cut out in a perimeter portion of the equator ring and radially corresponding to the end cavity in the weight core, and adapted to be filled into said notch as cut out in the equator ring for completing the equator ring for sealing said end cavity and for a smooth rotational engagement of the shell on the equator ring.

10. A massage device according to claim 6, wherein said pivoting shaft is fixed into the weight core, having an end cap for limiting a bushing secured in the hub portion; and said hub portion having ratchet teeth formed thereon for engaging a flange formed on the bushing for a quick fastening of the bushing in the hub portion of the shell.

11. A massage device according to claim 1, wherein said rotating spacer includes a male part having a key groove annularly recessed in the male part, and a female part engaged with the male part by inserting at least a key into the key groove for rotatably coupling the male part with the female part for rotatably coupling two said balls as spaced by said rotating spacer.
